(19) United States
(12) Patent Application Publication
(10) Pub. No.: US 2006/0125642 A1
(43) Pub. Date: Jun. 15, 2006

(54) Container with internal radio frequency identification tag

(76) Inventor: Ashok V. Chandaria, Nairobi (KE)

Correspondence Address: SAND & SEBOLT, AEGIS TOWER, SUITE 1100, 4940 MUNSON STREET, NW, CANTON, OH, 44718-3615, US

(21) Appl. No.: 11/001,924

(22) Filed: Dec. 2, 2004

(51) Int. Cl. G08B 13/14

(52) U.S. Cl. 340/572.8

(57) ABSTRACT

A container for a product including a security tag embedded within the layers of one of containers' exterior walls. The security tag is a radio frequency identification (RFID) tag and is not visibly detectable from outside of the container. The tag may only be detected by a reader which detects the tag through the layers of the wall of the container. The reader may be programmed to deactivate the tag when it is detected.

### BACKGROUND OF THE INVENTION

### TECHNICAL FIELD

This invention generally relates to security devices. More particularly, the invention relates to applying radio frequency identification (RFID) tags to products. Specifically, the invention relates to a packaging container which includes an RFID tag embedded between the layers of material from which the container is made.

### BACKGROUND INFORMATION

It has become common in merchandising to apply some form of identification or security tag to products. One of the fastest growing technologies is radio frequency identification (RFID). This technology allows a business to monitor products shipped to it, track inventory and gather information as to the exact location of products in their business premises. The industry is also starting to use RFID tags as theft deterrent devices. RFID tags contain microchips which are used to store relevant information about the contents of a pallet or package. The tags also contain an antenna and they are programmed to respond automatically to signal to transmit the requested relevant information to a reader device. In the case of theft deterrence, the readers are positioned at the exit to the store. As the product is taken past the reader, the RFID tags automatically signals the reader which in turn correlates the signal from the tag with information from the store cash registers. If there is no record of the RFID tag passing through the cash registers, an alarm is sounded.

RFID tags may be applied to products in the same manner as any other type of radio frequency, magnetic or electronic article surveillance (EAS) tags. They can be applied as part of a label or a plastic connector in which the tag is housed. The plastic connector is applied to the product in a way that prevents its ease of removal. So, for example, compact discs are sold in plastic cases that cannot be removed without a special key. The only way of removing the plastic case would be to smash the plastic case and more than likely damage the compact disc to the degree that it cannot be played. Clothing is marked by attaching a tag housed in a plastic case directly to the garment itself. Again, the only way to remove the plastic case without the appropriate key is to cause damage to the garment. Some security tags include identifiers to show whether the consumer has attempted to tamper with the tag. So, for example, some of the cases include dies that spill out over the article if the tag is damaged at all. Other tags are applied as labels which are adhesively attached to either the product or its packaging. In order to prevent easy removal of the labels, they are frequently produced with perforations so that only a small portion of the label can be pulled off the product at any one time. Alternatively, the tags are disguised so that they are not recognized as a security device. So, for example, the tags may be phony bar codes, blank stickers or even labels identifying the manufacturer's address.

Even with all the time and money invested in producing security tags, thieves still manage to find ways to disable or remove tags and to steal the products. There is therefore still a need in the art to mark products in a manner which aids in preventing the theft thereof.

### SUMMARY OF THE INVENTION

The device of the present invention is a packaging container into which an RFID tag is embedded. The tag is inserted between the layers of material from which the container is made. A reader may be used to locate and read the tag embedded in the layers of the container. Because the RFID tag is embedded, it is not visible to the potential thief and it is therefore impossible for the thief to locate without a reader unless they completely destroy the packaging for the product and thereby draw attention to themselves.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a container showing, in phantom, an RFID tag applied in accordance with the present invention;

FIG. 2 is a cross-sectional view through line 2-2 of FIG. 1; and

FIG. 3 shows the container being passed through a reader in order to gather information from the RFID tag.

### DETAILED DESCRIPTION OF THE INVENTION

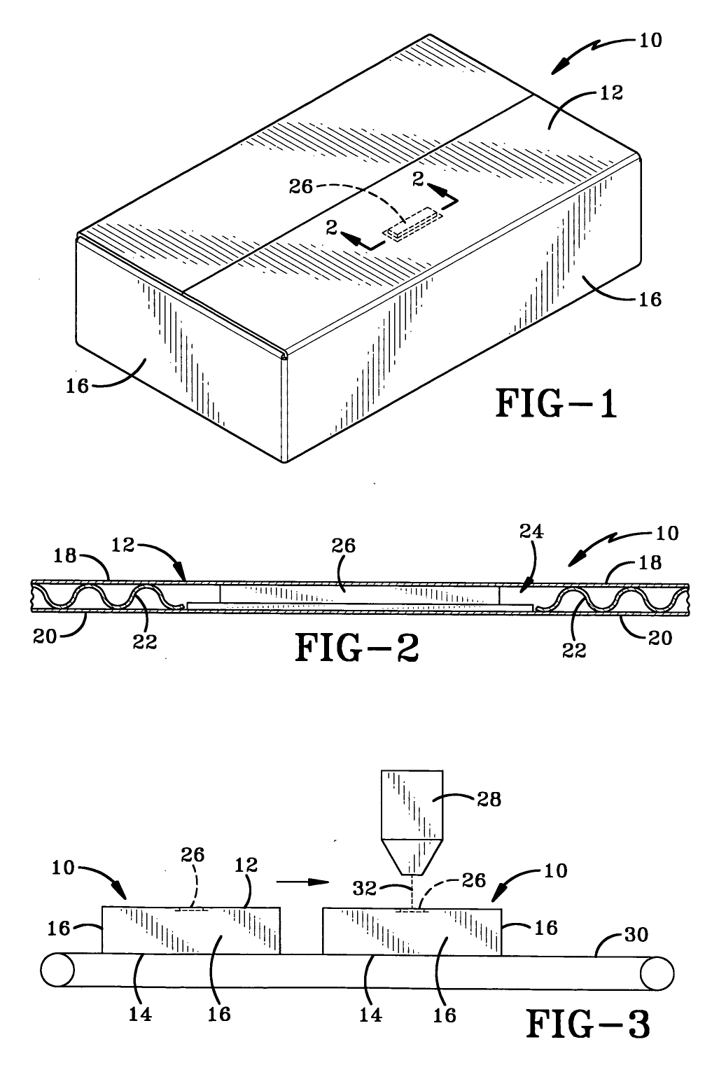

Referring to FIGS. 1&2, there is shown a container in accordance with the present invention and generally indicated at 10. Container 10 has a top wall 12, a bottom wall 14 and side walls 16. The product (not shown) is held within the interior of container 10.

Each of the top, bottom and side walls 12, 14, 16 preferably is made of corrugated cardboard or other like material which is neither transparent nor opaque. As shown in FIG. 2, top wall 12 includes an upper layer 18 and a lower layer 20 which are spaced apart from each other. A space exists between upper and lower layers 18, 20 and corrugations 22 are sandwiched between upper and lower layers 18, 20 in this space. Top wall 12 also includes a small pocket, generally indicated at 24, in which there are no corrugations 22. In accordance with one of the features of the present invention, the RFID tag 26 is positioned in this pocket 24. Tag 26 may be adhesively attached or otherwise connected to one of upper and lower layers 18, 20 so that tag 26 does not become dislodged during normal handling of the container 10. Tag 26 has to be enclosed into the cardboard or other material from which container 10 is made, prior to assembly of the container. Tag 26 may be provided with a variety of information. That information may include the type of product, a make or serial number, date of manufacture, price of the product etc.

Referring to FIG. 3, tag 26 is used in the following manner. The product (not shown) is delivered to the store in the container 10. Tag 26 is activated if necessary. When a consumer wishes to purchase the product, container 10 enclosing the product is scanned to let the purchaser know how much to pay for the product. When container 10 is moved along a conveyor belt 30 it may pass beneath a reader 28 (FIG. 3) and any relevant information is transmitted from tag 26 to reader 28 in response to a signal emitted by reader 28. Container 10 may alternatively be scanned by way of a hand-held reader (not shown). When container 10 passes through reader 28, the device emits a signal 32 which is received and responded to by RFID tag 26. At the same time price information is conveyed to the customer, purchasing information is gathered for comparison with information to be transmitted at a later time by a second reader (not shown) located at an exit to a store, for example. When container 10 is taken through that second reader, the second reader emits a signal which is detected by RFID tag 26 embedded in container 10, the tag 26 transmits the appropriate response. The response is correlated with the purchasing information gathered previously. If there is no correlation, i.e. if there is no indication that the product was purchased, then the store's alarm is sounded. RFID tag 26 may alternatively be deactivated as it passes through the first scanner at the check out when the product is purchased. If deactivated, tag 26 will pass undetected through the second reader and without causing an alarm to sound. If tag 26 is not deactivated by reader 28, then an alarm will sound if the container 10 is removed from the store.

It will be understood that the type of information stored on the RFID tag 26 may be tailored to any need the retailer may have and may be gathered by readers 28 located at the check out, at the exit to the store, on shelves in the store, at the entrance to a warehouse etc. Readers can read information from tags 26 from a distance ranging between 4 inches and 15 feet at present, but these distances are expected to increase as the technology progresses. Reader 28 may include a computer and therefore be self-contained and emit and respond itself to signals from tag 26. Alternatively, reader 28 may be linked to a mainframe computer which controls stock inventories, sales data and security programs. It will also be understood that container 10 may have walls which are greater in thickness than those shown in the attached drawings. Furthermore, while tag 26 is shown embedded in top wall 12, it will be understood that tag 26 may be embedded anywhere within the walls of container 10.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. In combination:
a container for a product comprising a plurality of walls joined together to form an interior cavity into which the product may be inserted; and wherein each of the walls includes at least an inner layer and an outer layer spaced a distance apart; and
a security identification tag; and wherein the security identification tag is inserted into a space disposed between the inner and outer layers of one of the walls of the container.

2. The combination of claim 1, wherein the walls further include a corrugated layer disposed between the inner and outer layers, and wherein a pocket is formed in the corrugated layer for receiving the security tag therein.

3. The combination of claim 2, wherein the security tag is adhesively connected to at least one of the upper and lower layers.

4. The combination of claim 1, wherein the security tag is a radio frequency identification tag.

5. The combination of claim 2, further comprising:
a reader; whereby the reader produces a signal for detecting the tag disposed between the inner and outer layers of one of the walls of the container.

6. The combination of claim 5, wherein the signal of the reader deactivates the tag once the tag is detected.

7. A container for a product comprising a box with a security tag embedded within a wall of the box, whereby the security tag is not visible to a potential consumer.

8. The container as defined in claim 7, wherein the security tag is a radio frequency identification tag.
